(19) United States
(12) Patent Application Publication
(10) Pub. No.: US 2018/0230014 A1
(43) Pub. Date: Aug. 16, 2018

(54) METHOD FOR COST-EFFICIENT INDUSTRIAL PRODUCTION OF GRAPHITE OXIDE, GRAPHENE OXIDE AND GRAPHENE

(71) Applicant: METOXS PTE LTD., Singapore (SG)

(72) Inventor: Abraham Jalbout, Tucson, AZ (US)

(21) Appl. No.: 15/751,813

(22) PCT Filed: Aug. 11, 2016
(86) PCT No.: PCT/US2016/046604

§ 371 Date: Feb. 9, 2018

Related U.S. Application Data
(60) Provisional application No. 62/203,419, filed on Aug. 11, 2015.

(51) Int. Cl. C01B 32/215; H01M 4/583; H01M 4/133; H01M 10/0525; C01B 32/225; C01B 32/184

(52) U.S. Cl. CPC C01B 32/215; H01M 4/583; C01B 32/184; H01M 10/0525; C01B 32/225; H01M 4/133

(57) ABSTRACT

A method of chemical oxidation and exfoliation of graphite ore using inorganic oxidizing potassium-type agents in an acid medium is disclosed. The product of the claimed method, according to electron microscopy analysis, is sheets or nanoscale graphene oxide plates with thicknesses less than 100 nm.

### CROSS REFERENCE TO RELATED APPLICATIONS

This application claims priority from Provisional Application No. 62/203,419 filed on Aug. 11, 2015, the entire contents of which are incorporated in their entirety.

### BACKGROUND OF THE INVENTION

### Field of the Invention

The invention relates to the industrial treatment of graphite ore using potassium-type inorganic oxidizing agents in an acid medium. More particularly, the invention relates to an improved method for preparing graphite oxide and graphene oxide using chemical oxidation and exfoliation to produce sheets or nanoscale graphene oxide plates with thicknesses less than 100 nm.

### Description of Related Art

### Graphite and Graphene

Graphite is a mineral that occurs naturally in metamorphic rock in different continents of the world, including Asia, South America and some parts of North America. It is formed as a result of the reduction of sedimentary carbon compounds during metamorphism. Graphite is one of only three naturally occurring allotropes of carbon (the others being amorphous carbon and diamond). The difference between the three naturally occurring allotropes is the structure and bonding of the atoms within the allotropes; diamond enjoying a diamond lattice crystalline structure, graphite having a honeycomb lattice structure, and amorphous carbon (such as coal or soot) having no crystalline structure. The chemical bonds in graphite are actually stronger than those that make up a diamond; however, diamonds contain three-dimensional lattice bonds, while graphite consists of two-dimensional lattice bonds (layers of carbon sheets). While within each layer of graphite the carbon atoms contain very strong bonds, the layers are able to slide across each other, making graphite a softer, more malleable material.

Graphite is commonly used in thermochemistry as the standard state for defining the heat formation of compounds made from carbon. It is found naturally in three different forms: crystalline flake, amorphous and lump or vein graphite, and depending on its form, is used for a number of different applications. For example, it is well-known in the art that graphite possesses several advantageous properties including its ability to conduct electricity and heat, having the highest natural stiffness and strength even in temperatures exceeding 3600 degrees Celsius, and it is also self-lubricating and highly resistant to chemical attack.

Graphite has a planar, layered structure; each layer being made up of carbon atoms covalently bonded in a hexagonal lattice. These covalent bonds are extremely strong, and the carbon atoms within each sheet are separated by approximately 0.142 nm. Chemically, the carbon atoms are linked together by very sturdy sp²-hybridized bonds in a single layer of atoms, two dimensionally. Each individual, two dimensional, one atom thick layer of sp²-bonded carbon atoms in graphite is separated by 0.335 nm. Essentially, the crystalline flake form of graphite, as noted above, is simply hundreds of thousands of individual layers of linked carbon atoms stacked together.

In very basic terms, graphene could be described as a single, one atom thick layer of the commonly found mineral graphite; graphite is essentially made up of hundreds of thousands of layers of graphene. In actuality, the structural make-up of graphite and graphene, and the method of how to create one from the other, is slightly more complex. Graphene is fundamentally one single layer of graphite; a layer of sp²-bonded carbon atoms arranged in a honeycomb (hexagonal) lattice. However, graphene offers some impressive properties that exceed those of graphite as it is isolated from its ‘base material,’ graphite. For example, graphite is naturally a very brittle compound and cannot be used as a structural material on its own due to its sheer planes (although it is often used to reinforce steel). Graphene, on the other hand, is the strongest material ever recorded, more than three hundred times stronger than A36 structural steel, at 130 gigapascals, and more than forty times stronger than diamond.

Due to graphite's planar structure, its thermal, acoustic and electronic properties are highly anisotropic, meaning that phonons travel much more easily along the planes than they do when attempting to travel through the planes. Graphene, on the other hand, being a sheet of sp²-hybridized carbon of monatomic thickness and having very high electron mobility, offers fantastic levels of electronic conduction due to the occurrence of a free pi (π) electron for each carbon atom. As a result of these properties, graphene has attracted great interest in recent years in a variety of applications such as: conversion and storage of energy (solar cells, supercapacitors), electronics (circuits based on graphene), etc. See, e.g., Camblor R., Hoeye S. V., Hotopan G., Vázquez C, Fernández M., Las Heras F., Alvarez P., Menéndez R., “Microwave frequency tripler based on a microstrip gap with graphene.” J. Electromag. Waves Appl. 2011, 25 (14-15), 1921-1929.

### Graphite Oxide and Graphene Oxide

As noted previously, graphite is a 3-dimensional carbon based material made up of hundreds of thousands, or even millions, of layers of graphene. Through the oxidation of graphite using strong oxidizing agents, oxygenated functionalities are introduced into the graphite structure which not only expand the layer separation, but also render it hydrophilic (i.e., it can be dispersed in water). This enables the graphite oxide to be exfoliated in water using sonication, ultimately producing single or few-layer graphene, known as graphene oxide (GO). The main difference between graphite oxide and graphene oxide is, thus, the number of layers. While graphite oxide is a multilayer system, in a graphene oxide dispersion a few layers flakes and monolayer flakes can be found.

There are numerous references detailing the use of graphite as a precursor in the preparation of graphene, as the oxidation of graphite with a strong oxidizing agent to produce the graphene oxide has been known since the nineteenth century. For example, in the well-known “Hummers method” used for the treatment of graphite sodium nitrate, potassium permanganate and concentrated sulfuric acid, are mixed in order with the graphite. See Hummers W. S., Offeman R. E. “Preparation of Graphitic Oxide,” J. Am. Chem. Soc., 1958, 80 (6), 1339-1339. What makes graphite particularly useful in the preparation of graphenes is its anisotropic, polycrystalline structure of carbon composite sheets (sp2-covalently bonded) which are stacked three-dimensionally and held together by relatively strong van der Waals force.

In the method of the claimed invention, a large number of oxygen-containing functional groups have been introduced onto both sides of a single graphite sheet (i.e., graphene). The oxygen-containing functional groups repel one another, and this repulsive force overcomes the inter-sheet van der Waals force and increases the interlayer spacing. The sheets in such an expanded structure are then easily pulled open using an external force such as ultrasonic vibration (i.e., sonication). The expanded graphite is thus exfoliated into multi-layered or even single-layered sheets.

One of the problems in the implementation of the aforementioned conventional systems of producing graphite oxide on an industrial scale is that graphite oxide, graphene oxide and/or graphene can only be manufactured at medium or large scale. Thus, large-scale preparation of graphene remains one of the most important areas for future research.

At present the preparation of graphene from graphite ore by chemical methods is the one method that provides for scaling in production and is the most promising in terms of large-scale industrial exploitation. In particular, oxidation/exfoliating/reduction of naturally-occurring graphite ore is the most widespread method producing graphite oxide/graphene oxide/graphene. In this process, the oxidation of three-dimensional graphite material having a lamellar structure yields graphite sheets with oxidized basal planes and borders having an expanded three-dimensional structure. The delamination/exfoliation of graphite oxide using an external force such as sonication yields a material called graphene oxide. Finally, reducing the graphene oxide to form unilamellar (single layer) sheets, which can be produced by various methods, results in the graphene. Furthermore, in addition to the well-known benefits of graphene, the intermediate products (graphite oxide and graphene oxide) are materials which in and of themselves have much interest and commercial application. See, e.g., González Z., Botas C, Alvarez P., Roldán S., Blanco C, Santamaría R., Granda M., Menendez R., “Thermally reduced graphite oxide as possitive electrode in vanadium redox flow batteries.” Carbón, 2012, 50 (3), 828-834.

### OBJECTS OF THE INVENTION

It is an object of the present invention to describe a method of treating graphite ore, which is obtained easily and with greater availability than other graphitic materials, to produce graphite oxide, graphene oxide and/or graphene.

It is a further object of the present invention to describe a method of treating raw graphite ore without regard to particle size, i.e., where the method can be employed without the additional step of controlling for particle size.

It is a still further object of the present invention to describe a method of treating raw graphite ore for use in applications such as catalysts, microelectronics and energy storage.

Perhaps the most important object of the instant invention is to achieve all of the above objects using readily available, naturally-occuring, and relatively affordable graphite ore, in a method that has few harmful effects on the environment and human health.

### SUMMARY OF THE INVENTION

In the present invention, graphite ore is ground to a fineness of 100-150 microns, and purified by flotation in twice-distilled water at a temperature of approximately 90 degrees Celsius. Next, the purified ore is oxidized to yield graphite oxide using an oxidizing reagent such as potassium permanganate, sodium nitrate and/or concentrated sulfuric acid to yield graphite sheets with oxidized basal planes and borders having an expanded three-dimensional structure. In a subsequent step, delamination/exfoliation of graphite oxide using an external force such as sonication yields a material called graphene. Finally, reducing the graphene oxide to form unilamellar (single layer) sheets results in the graphene.

### BRIEF DESCRIPTION OF THE DRAWING(S)

FIG. 1 is a flow-diagram of the claimed invention illustrating the sequential order of the claimed method steps.

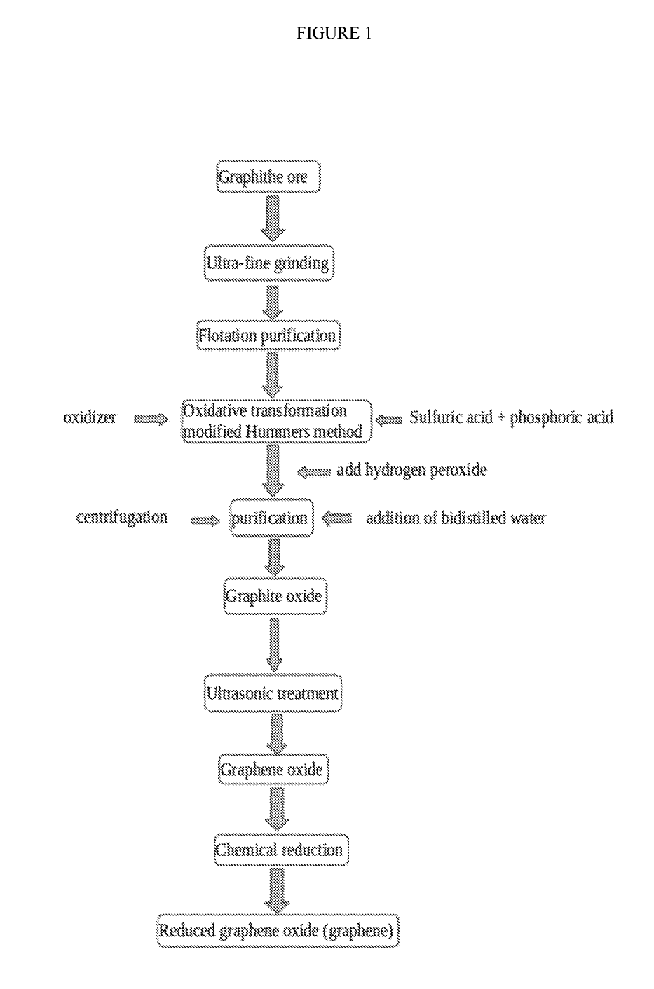

### DETAILED DESCRIPTION OF THE INVENTION

The method of the present invention, which is particularly suited to scaling and industrial use, employs a novel variant of the well-known “Hummers Method,” which yields graphite oxide that, with subsequent exfoliation, produces graphene oxide. In the method described in the present invention, other products such as graphene oxide and reduced oxide graphene (graphene), valuable materials themselves, can also be obtained by applying conventional methods. The present invention therefore provides an advantageous method of producing—at industrial scale—graphite oxide, graphene oxide and/or graphene, as raw graphitic materials (mineral graphite, etc.) are easily available in Sonora State in Mexico, and there is abundant mineral graphite worldwide and its exploitation is much cheaper than synthetic graphite or other high priced graphitic derivative materials.

The use of graphite ore has many current economic, environmental, energy and strategic advantages as it is a product that is naturally occurring in abundance approximately 100 km from the city of Hermosillo Sonora in Mexico, where it is marketed for many standard applications in industry, thereby ensuring a ready supply. The economic interest of implementing the method of the present invention is thus very high.

Therefore, an aspect of the present invention relates to an industrial process, hereinafter referred to as the claimed process, for obtaining graphite oxide from readily available graphitic materials (graphite ore). Subsequent sheet separation can be accomplished by exfoliation or intercalation thermal shock, among other techniques known to anyone skilled in the matter. Preferably the sheet separation is carried out by exfoliation using ultrasound (sonication).

In application, the claimed process, besides the direct production of graphite oxide by oxidative transformation of graphite ore, can be used to obtain other products such as graphene oxide and/or graphene, by adding intermediate reaction steps. Therefore, in another particular embodiment, the method further comprises the following process steps:
a) a process of ultra-fine grinding of ore graphite to less than 150 microns (μm) in size, preferably 100-150 microns (μm),
b) flotation purification of ore graphite in bi-distilled water at a temperature of 90° C.,
c) graphite oxidative transformation of b) to graphite oxide,
d) separation and/or purification of the graphite oxide obtained in the oxidation of graphite in c),
e) obtaining graphene oxide from graphite oxide obtained in d), and
f) obtaining graphene from graphene oxide of e);
where the temperature at any stage is less than 200° C., preferably below 100° C. In a preferred embodiment, all steps are performed sequentially.

In one embodiment of the claimed method, the graphitic material a) is graphite ore material obtained easily and with greater availability than other conventional graphitic materials known in the manufacture of graphene.

In the claimed invention, the graphitic material may also be used without controlling the particle size; however, if particle size is not controlled for, longer reaction times may be required, and/or the use of additional oxidizing agents such as those indicated above. Thus, in another embodiment of the claimed invention, step a) is omitted, and the method commences at step b) or c).

A particular embodiment of the invention is the method of the invention wherein step c) transformation of graphite in a) or b) in graphite oxide by chemical treatment of graphite is conducted using as reagents potassium permanganate, sulfuric acid, phosphoric, hydrogen peroxide and bi-distilled water, although the method is not limited to those reagents.

In a further preferred embodiment, the method of the present invention step c) of transforming graphite in a) or b) in graphite oxide is conducted by a chemical treatment using weight ratios of graphite/potassium permanganate from ¼ to ⅛ depending on the quality of graphite. Preferred reaction volumes corresponding to 87.5 vol % sulfuric acid and 12.5 vol % phosphoric acid, adding at the end of 0.75% hydrogen peroxide, the percentages being expressed by volume relative to the total reaction volume, these being variable preferable ratios depending on the material characteristics.

Another particular object of the invention is the method of the invention in which step d) purification of the graphite oxide obtained in the oxidation of graphite in c) is carried out by, for illustrative purposes and without limiting the scope of the invention, a technique belonging to the following group: decanting the supernatant and centrifugation. In a further preferred embodiment, this purification takes place by repeating in sequence the aforementioned separation of oxides, after adding distilled water, until the decanted water has a pH measurement between 3 and 4. However, another type of water may also be used to wash the obtained graphite oxide, along with any other conventional method such as, for example, filtration, dialysis or addition of other solvents.

Thus, a particular object of the invention is the method of the invention in which step e) of obtaining graphene oxide from graphite oxide obtained in d) is carried out by separating the sheets of graphene oxide.

A particular embodiment of the invention is the method of the invention in which the separation of the sheets of graphene oxide of step e) is performed by a technique, for illustrative purposes and without limiting the scope of the invention, to the following group: exfoliation and thermal shock. Moreover, in this direction the method described in this patent application may comprise the delamination of graphene oxide, accompanied by a reduction of oxygen functional groups, for example by heat treatment without exfoliates oxide material. See US2009/0028777A1.

In a further preferred embodiment, the separation of the sheets of graphene oxide of step e) of the method of the invention is carried out by exfoliating oxides prepared from ore graphite by ultrasonic treatment. This should be done in periods between 60 minutes to six hours in order to produce graphene oxide.

Another particular object of the invention is the method of the invention in which step f) to obtain graphene from graphene oxide e) is performed by, for illustrative purposes and without limiting the scope of the invention, a technique of reducing using one or more reducing agents selected from among the following group: as chemical reduction with hydrogen, electrochemical and combinations thereof. See also WO2011/016889A2 (examples of reductions in oxides of graphite and graphene oxides).

Another object of the invention is the product obtained by the method of the invention, hereinafter product of the invention, wherein the product belongs to the following group: graphite oxide, graphene oxide and graphene.

Finally, another object of the invention is the use of the product of the invention for applications such as, for illustrative purposes and without limiting the scope of the invention, those belonging to the following group: catalysts, microelectronics and energy storage. See also Han D. L., Yan L. F., Chen W. F., Li W., “Preparation of chitosan/graphene oxide composite film with enhanced mechanical strength in the wet state.” CARBOHYD. POLYM., 2011, 83, 653-658 and González Z., Botas C, Alvarez P., Roldán S., Blanco C, Santamaría R., Granda M., Menendez R. “Thermally reduced graphite oxide as possitive electrode in vanadium redox flow batteries.” CARBÓN, 2012, 50 (3), 828-834.

### EXAMPLES

The following describes a series of tests performed by the inventor, which are representative of the effectiveness and scalability of the method of the invention for using graphite ore to preparing graphite oxide, graphene oxide and graphene.

### Example 1

### Using 4 g of Graphite Ore to Produce its Oxide and Graphene Oxide by Chemical Means

Obtaining graphite oxide from ore graphite was performed as follows. In a beaker of 500 ml are added 50 ml of phosphoric acid to 85% and 350 ml of sulfuric acid at 98% at room temperature, a magnetic bar is added and placed in a grill with stirring for 10 minutes. Subsequently, 4 g of ore graphite, having been ground to a fineness of less than 150 microns, is added and continuously stirred for 10 minutes and then added slowly 24 grams of potassium permanganate, the temperature is raised to 65° C. and left stirring for 8 hours. After the reaction mixture is transferred to a beaker of 1 liter containing 400 ml of bi-distilled water previously frozen and subsequently 3 ml of hydrogen peroxide to 30% are added again and allowed to stir at room temperature for 30 minutes. Let stand for 20 hours. The supernatant was stored and decanted material is transferred to centrifuge tubes and centrifuged at 4500 rpm for 15 minutes. The solid obtained is transferred to a beaker and bi-distilled water is added and stirring is maintained for one hour and allowed to stand for 20 hours, and the rest and above procedure is repeated centrifugation until the pH of the decanted solution around 3 to 4 solution (measured with digital pH meter). The solid thus obtained is graphite oxide from ore graphite.

To obtain graphene oxide, the graphite oxide was subjected to an ultrasonic treatment at room temperature for 270 minutes. That time is required for delamination and formation of the corresponding graphene oxide.

Example 2

### Using 20 g of Graphite Ore to Produce its Oxide and Graphene Oxide by Chemical Means

Obtaining graphite oxide from ore graphite was performed as follows. In a beaker of 4 liters were added 250 ml of phosphoric acid to 85% and 1750 ml of sulfuric acid at 98% at room temperature, a magnetic bar is added and placed in a grill with stirring for 10 minutes. Subsequently, 20 g of ore graphite, having been ground to a fineness of less than 150 microns, is added and continuously stirred for 10 minutes and then added slowly 120 grams of potassium permanganate, the temperature is raised to 65° C. and left stirring for 8 hours. After the reaction mixture is transferred to a beaker of 4 liters containing 2 liters of bi-distilled water previously frozen and subsequently 15 ml of hydrogen peroxide to 30% are added again and allowed to stir at room temperature for 30 minutes. Let stand for 20 hours. The supernatant was stored and decanted material is transferred to centrifuge tubes and centrifuged at 4500 rpm for 15 minutes. The solid obtained is transferred to a beaker and bi-distilled water is added and stirring is maintained for one hour and allowed to stand for 20 hours, and the rest and above procedure is repeated centrifugation until the pH of the decanted solution around 3 to 4 (measured with digital pH meter). The solid thus obtained is graphite oxide from ore graphite.

To obtain graphene oxide, the graphite oxide was subjected to an ultrasonic treatment at room temperature for 270 minutes. That time is required for delamination and formation of the corresponding graphene oxide.

1. An industrial method of producing large-scale quantities of graphite oxide, graphene oxide and/or graphene, the method comprising the steps of:
a. ultrafine grinding of graphite ore;
b. flotation purification of graphite ore in bi-distilled water; at a temperature of 90° C. or lower,
c. graphite oxidative transformation of b) to graphite oxide;
d. separation and/or purification of the graphite oxide obtained in the oxidation of graphite in c);
e. obtaining graphene oxide from graphite oxide obtained in d); and
f. obtaining graphene from graphene oxide of e) at a temperature less than 200°C.

2. The method of claim 1, further comprising the step of separating sheet graphite ore at a temperature below 200° C.

3. The method according to claim 1, wherein ultrafine grinding comprises grinding the graphite ore to a fineness of less than 150 microns.

4. The method of claim 2, wherein the sheet separation is conducted by exfoliation or intercalation.

5. The method of claim 4, wherein the sheet separation is carried out with chemical treatments.

6. The method of claim 4, wherein the sheet separation further comprises the use of ultrasound.

7. The method of claim 1, wherein step f) is performed at a temperature less than 100° C.

8. The method of claim 1, wherein step c) is performed by a technique belonging to the following group: treatment or chemical reduction, intercalation, exfoliation and reduction with hydroiodic acid.

9. The method of claim 8, wherein step c) is carried out by chemical treatment of the graphite ore using potassium permanganate, sulfuric acid, hydrogen peroxide and distilled water.

10. The method of claim 9, wherein step c) is carried out by chemical treatment of graphite ore using:
weight ratios of graphite ore/potassium permanganate among ¼ to ⅛; and
a reaction volume consisting of:
79.625 vol % of sulfuric acid to 98%, 19.625 vol % of phosphoric acid at 85%, and 0.75 vol % hydrogen peroxide at 30%; or
87.125 vol % of sulfuric acid to 98%, 12.125 vol % of phosphoric acid at 85%, and 0.75 vol % hydrogen peroxide at 30%; or
89.625 vol % of sulfuric acid to 98%, 9.625 vol % of phosphoric acid at 85%, and 0.75 vol % hydrogen peroxide at 30%.

11. The method of claim 1, wherein step d) is performed by a technique belonging to the following group: centrifugation and decantation of the supernatant.

12. The method of claim 1, further comprising the step of separating sheet graphite ore at a temperature below 100° C.

13. The method of claim 1, wherein step e) is performed by separating the sheets of graphene oxide.

14. The method of claim 13, wherein the separation of the sheets of graphene oxide is performed using a technique belonging to the following group: intercalation and exfoliation.

15. The method of claim 14, wherein the separation of the sheets is performed by ultrasonic exfoliation.

16. The method of claim 1, wherein ultrafine grinding comprises grinding the graphite ore to a fineness of less than 100-150 microns.

17. The method of claim 1, wherein step f) is performed by a technique of reducing the graphene oxide to the following group: chemical reduction with hydroiodic acid, electrochemical and combinations thereof.

18. A product obtained by the method of claim 1, wherein the product is graphite oxide, graphene oxide or graphene.

19. (canceled)

20. A method of using the product of claim 18 for applications in catalysis.

21. A method of using the product of claim 18 for applications in microelectronics.

22. A method of using the product of claim 18 for applications in energy storage.
